(19) United States
(12) Patent Application Publication
(10) Pub. No.: US 2025/0197214 A1
(43) Pub. Date: Jun. 19, 2025

(54) HYDROGEN PRODUCTION SYSTEM AND METHOD FOR PRODUCING HYDROGEN USING THE SAME

(71) Applicants: HYUNDAI MOTOR COMPANY, SEOUL (KR); KIA CORPORATION, SEOUL (KR)

(72) Inventors: Dong Seok Ko, Yongin-si (KR); Jung Joo Park, Seoul (KR)

(73) Assignees: HYUNDAI MOTOR COMPANY, SEOUL (KR); KIA CORPORATION, SEOUL (KR)

(21) Appl. No.: 18/739,700

(22) Filed: Jun. 11, 2024

(30) Foreign Application Priority Data
Dec. 15, 2023 (KR) 10-2023-0183515

(51) Int. Cl. C01B 3/48; C01B 3/50

(52) U.S. Cl. CPC C01B 3/48; C01B 3/508; C01B 2203/0233; C01B 2203/0238; C01B 2203/0288; C01B 2203/042; C01B 2203/0475; C01B 2203/0827; C01B 2203/1241; C01B 2203/141; C01B 2203/145; C01B 2203/1685; C01B 2203/169

(57) ABSTRACT

A hydrogen production system and a method for producing hydrogen that may minimize carbon dioxide emissions of an overall process by combining a steam-methane reformation process with a combined steam-carbon reformation process, and using a feed controller to appropriately control flow rates of steam and hydrocarbon gas feed input to the combined steam-carbon reformation process based on a composition and a flow rate of off-gas input from the steam-methane reformation process to the combined steam-carbon reformation process.

### CROSS REFERENCE TO RELATED APPLICATIONS

This application claims the benefit of priority to Korean Patent Application No. 10-2023-0183515, filed in the Korean Intellectual Property Office on Dec. 15, 2023, the entire contents of which are incorporated herein by reference.

### TECHNICAL FIELD

The present disclosure relates to a hydrogen production system that may reduce carbon dioxide emissions and a method for producing hydrogen using the same.

### BACKGROUND

Hydrogen is attracting attention as an eco-friendly energy source because it generates only water during combustion, and various studies are being conducted in terms of a method for producing hydrogen.

Among various methods for producing hydrogen, the widely known one is a hydrogen production method using a steam-methane reformation process. The steam-methane reformation process is a process that may produce hydrogen using methane gas and steam as raw materials. The steam-methane reformation process converts the methane gas into hydrogen via two-stage reactions of a steam-methane reformation reaction and a water gas shift reaction of carbon monoxide contained in gas produced after the reformation reaction. A specific reaction formula in each stage and overall reaction formulas are as follows.

CH₄+H₂O→CO+3H₂ Reaction Formula 1

CO+H₂O→CO₂+H₂ Reaction Formula 2

CH₄+2H₂O→CO₂+4H₂ Reaction Formula 3

From mixed gas of carbon dioxide and hydrogen obtained via such process, only hydrogen gas may be separated to produce high purity hydrogen gas.

In addition to the hydrogen production method using the steam-methane reformation process, a known hydrogen production method includes a combined steam-carbon reformation process. In the combined steam-carbon reformation process, in addition to the steam-methane reformation process described above, a carbon dioxide reaction in which methane and carbon dioxide react to produce carbon monoxide and hydrogen is performed along with the steam-methane reformation reaction. A reaction formula for the carbon dioxide reaction is as follows.

CH₄+C0₂→2CO+2H₂ Reaction Formula 4

In the combined steam-carbon reformation process, the steam-methane reformation reaction and the carbon dioxide reaction described above are performed simultaneously, and a ratio of carbon monoxide and hydrogen in gas produced via the reactions may be determined based on a reaction ratio therebetween. Mixed gas of carbon monoxide and hydrogen obtained via such process is converted into carbon dioxide and hydrogen gas via the water gas shift reaction as in the steam-methane reformation process described above. From such mixed gas, only hydrogen gas may be selectively separated to produce high purity hydrogen gas.

However, the two known processes as described above have a disadvantage of emitting carbon dioxide. In particular, in the case of the combined steam-carbon reformation process, carbon dioxide itself is input as a feed, but because carbon dioxide consumed in the reaction must also be heated at a high temperature, a great amount of carbon dioxide is emitted in such process. Further, because research on a reaction catalyst and optimization of process conditions is still lacking, a greater amount of carbon dioxide is emitted compared to the steam-methane reformation process, which has already been sufficiently studied.

Therefore, further research is needed on the hydrogen production system and the method for producing hydrogen that may produce hydrogen gas with high efficiency while reducing the carbon dioxide emissions.

### SUMMARY

The present disclosure has been made to solve the above-mentioned problems occurring in the prior art while advantages achieved by the prior art are maintained intact.

An aspect of the present disclosure provides a hydrogen production system and a method for producing hydrogen using the same that may solve the above problems.

Another aspect of the present disclosure provides a new hydrogen production system and a method for producing hydrogen that may produce hydrogen gas with high efficiency, and at the same time, significantly reduce an amount of carbon dioxide emitted.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a new hydrogen production system and a method for producing hydrogen using the same are provided.

According to another aspect of the present disclosure, a hydrogen production system includes a steam-methane reformer that receives steam and hydrocarbon gas, a first conversion reactor in fluid communication with the steam-methane reformer, a first adsorption separation process unit that is in fluid communication with the first conversion reactor and separates high purity hydrogen gas, a combined steam-carbon reformer that receives steam and hydrocarbon gas, a second conversion reactor in fluid communication with the combined steam-carbon reformer, and a second adsorption separation process unit that is in fluid communication with the second conversion reactor and separates high purity hydrogen gas, the first adsorption separation process unit is connected to and in fluid communication with the combined steam-carbon reformer, and the hydrogen production system includes a feed controller that controls flow rates of steam and hydrocarbon gas introduced into the combined steam-carbon reformer based on a composition and a flow rate of off-gas flowing into the combined steam-carbon reformer from the first adsorption separation process unit.

According to another aspect of the present disclosure, a method for producing hydrogen includes allowing steam and methane to react with each other to obtain first stream containing carbon monoxide gas, steam, and hydrogen gas, performing conversion reaction on the first stream to obtain second stream containing carbon dioxide gas and hydrogen gas, obtaining hydrogen gas by separating the same from the second stream and adding and reacting additional steam and methane to remaining off-gas to obtain third stream containing carbon monoxide gas, steam, and hydrogen gas, performing the conversion reaction on the third stream to obtain fourth stream containing carbon dioxide gas and hydrogen gas, and obtaining hydrogen gas by separating the same from the fourth stream, and molar flow rates of additional steam and hydrocarbon gas introduced into off-gas are determined via Equations 1 and 2 below:

$$[ Feed {H}_{2} O ] = [ {CO}_{2} ] \times [ Eq 2 ] - [ {H}_{2} O ] \qquad Equation 1$$

$$[ Feed {CH}_{4} ] = ( [ {CO}_{2} ] \times ( 1 + [ Eq 2 ] ) ) / [ Eq 1 ] - [ {CH}_{4} ] \qquad Equation 2$$

In Equation, [CO₂] refers to a molar flow rate (kmol/hr) of carbon dioxide gas in off-gas,
[H₂O] refers to a molar flow rate (kmol/hr) of steam in off-gas,
[CH₄] refers to a molar flow rate (kmol/hr) of methane gas in off-gas,
[Eq1] is a constant between 1.5 and 2.0, and
[Eq2] is a constant equal to or greater than 1.

### BRIEF DESCRIPTION OF THE FIGURES

The above and other objects, features and advantages of the present disclosure will be more apparent from the following detailed description taken in conjunction with the accompanying drawings:

FIG. 1 is a diagram briefly showing a hydrogen production system of the present disclosure; and

FIG. 2 is a graph showing simulation results according to Experimental Example of the present disclosure.

### DETAILED DESCRIPTION

Hereinafter, the present disclosure will be described in more detail.

Terms or words used herein and claims should not be construed as limited to their usual or dictionary meanings, and should be interpreted to have meanings and concepts consistent with the technical idea of the present disclosure based on a principle that the inventor is able to appropriately define concepts of the terms to describe the invention thereof in the best way possible.

### Hydrogen Production System

In a case of a combined steam-carbon reformation process, carbon dioxide gas must be input in addition to methane gas and steam as a feed. Stream obtained via a water gas shift reaction in a steam-methane reformation process contains carbon dioxide gas, methane gas, and steam gas along with hydrogen gas. In other words, off-gas remaining after hydrogen is finally separated in the steam-methane reformation process contains the same components contained in a feed of the combined steam-carbon reformation process. Based on the above, the inventor of the present disclosure combined the steam-methane reformation process with the combined steam-carbon reformation process, and used the final off-gas from the steam-methane reformation process as the feed in the combined steam-carbon reformation process to derive a hydrogen production system of the present disclosure that may emit a smaller amount of carbon dioxide compared to an amount of hydrogen obtained.

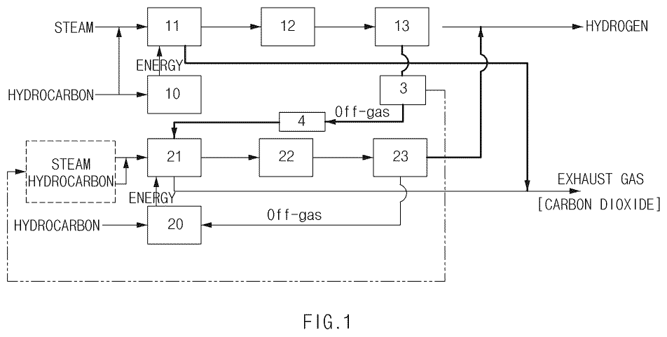

Hereinafter, each component included in the hydrogen production system of the present disclosure will be separately described with reference to FIG. 1.

### Steam-Methane Reformation Process

The hydrogen production system of the present disclosure combines the steam-methane reformation process with the combined steam-carbon reformation process, and the hydrogen production system of the present disclosure includes the same components included in the steam-methane reformation process.

More specifically, as shown in FIG. 1, the present disclosure may include a steam-methane reformer 11 that receives steam and hydrocarbon gas, a first conversion reactor 12 in fluid communication with the steam-methane reformer, and a first adsorption separation process unit 13 that is in fluid communication with the first conversion reactor and separates high purity hydrogen gas, and the steam-methane reformer, the first conversion reactor, and the first adsorption separation process unit may be collectively referred to as the steam-methane reformation process.

The steam-methane reformer 11 allows steam and methane to react with each other to generate carbon monoxide gas and hydrogen gas. The reaction performed in the steam-methane reformation unit 11 may be represented by Reaction Formula 1 below.

CH₄+H₂O→CO+3H₂ Reaction Formula 1

The reaction may be performed in the presence of a steam-methane reformation catalyst containing Ru or Ni under a temperature condition equal to or higher than 600° C. and equal to or lower than 1000° C.

In one example, in the steam-methane reformer 11, in addition to the reaction between steam and methane described above, reactions between steam and other types of hydrocarbon contained in hydrocarbon gas may be performed in the same manner.

Steam and hydrocarbon gas may be respectively injected into the steam-methane reformer 11 via separate lines, or as shown in FIG. 1, steam and hydrocarbon gas may be mixed with each other in advance and then injected via one line.

Hydrocarbon gas is not particularly limited as long as it contains methane gas. More specifically, natural gas, liquefied natural gas (LNG), liquefied petroleum gas (LPG), and the like may be used as the hydrocarbon gas.

A molar ratio between steam and methane gas contained in hydrocarbon gas introduced into the steam-methane reformer 11 may be in a range from 2.5:1 to 4:1, and preferably in a range from 3:1 to 4:1. Considering an amount of steam consumed in the water gas shift reaction to be described later and an amount of steam consumed in the steam-methane reformation reaction, a molar ratio between steam and methane gas of 2:1 corresponds to an equivalent, but injecting a greater amount of steam than necessary in the actual reaction may be effective in preventing coking of the catalyst.

In one example, some of the hydrocarbon gas may be injected into a first burner 10 and burnt to be used as an energy source for heat supplied to the steam-methane reformer 11. A certain amount of energy is required to perform the steam-methane reformation reaction. The overall process may be designed more simply using some of a hydrocarbon feed input to the steam-methane reformer 11 in supplying the energy.

Carbon monoxide gas and hydrogen gas generated via the steam-methane reformer 11 and remaining steam that failed to react in the steam-methane reformer are directly input into the first conversion reactor 12, and the input carbon monoxide gas and steam go through the water gas shift reaction represented by Reaction Formula 2 below.

CO+H₂O→CO₂+H₂ Reaction Formula 2

The reaction may be performed in the presence of a water gas shift reaction catalyst containing Fe/Cr or Cu/Zn under a temperature condition equal to or higher than 100° C. and equal to or lower than 400° C.

When summarizing the steam-methane reformation reaction and the water gas shift reaction performed as in Reaction Formula 1 and Reaction Formula 2, the total reaction performed via the steam-methane reformer 11 and the first conversion reactor 12 may be represented by Reaction Formula 3 below.

CH₄+2H₂O→CO₂+4H₂ Reaction Formula 3

Stream produced via the first conversion reactor 12 may contain excessively added steam and unreacted methane gas along with carbon dioxide and hydrogen. Such stream may be input into the first adsorption separation process unit 13, where hydrogen may be separated and discharged, and off-gas containing the remaining components excluding hydrogen may be input into a combined steam-carbon reformer 21, which will be described later. In the first adsorption separation process unit 13, only high purity hydrogen gas may be separated by adsorbing and removing gases other than hydrogen.

In one example, the hydrogen production system of the present disclosure may further include a first exhaust gas processor that is connected to the steam-methane reformer and is for processing exhaust gas discharged from the steam-methane reformer. Specifically, high-temperature gas generated from the first burner may be input into the steam-methane reformer to supply the energy, and the high-temperature gas whose energy is entirely supplied may be discharged from the steam-methane reformer as low-temperature exhaust gas.

### Combined Steam-Carbon Reformation Process

The hydrogen production system of the present disclosure includes the combined steam-carbon reformation process along with the steam-methane reformation process described above. More specifically, as shown in FIG. 1, the combined steam-carbon reformation process may include the combined steam-carbon reformer 21 that receives steam and hydrocarbon gas, a second conversion reactor 22 in fluid communication with the combined steam-carbon reformer, and a second adsorption separation process unit 23 that is in fluid communication with the second conversion reactor and separates high purity hydrogen gas, and the combined steam-carbon reformer 21 may be connected to the first adsorption separation process unit 13 to be in fluid communication therewith.

The combined steam-carbon reformer 21 allows the input steam and hydrocarbon gas to react with carbon dioxide, steam, and methane in the off-gas separated in the first adsorption separation process unit 13 to produce carbon monoxide gas and hydrogen gas.

In the combined steam-carbon reformer, the reaction represented by Reaction Formula 1 described above and a reaction represented by Reaction Formula 4 below are performed simultaneously.

CH₄+C0₂→2CO+2H₂ Reaction Formula 4

The reaction may be performed in the presence of a combined steam-carbon reformation catalyst containing Ru or Ni under a temperature condition equal to or higher than 600° C. and equal to or lower than 1000° C.

In a typical combined steam-carbon reformation process, separate carbon dioxide is introduced as a feed to induce the reaction represented by Reaction Formula 4, but in the hydrogen production system of the present disclosure, carbon dioxide generated as a result of the steam-methane reformation process in the previous stage is used as the feed in the combined steam-carbon reformation process, thereby reducing an amount of carbon dioxide emitted and increasing hydrogen productivity.

Steam and hydrocarbon gas may be respectively introduced into the combined steam-carbon reformer 21 via separate lines, or as shown in FIG. 1, steam and hydrocarbon gas may be mixed with each other in advance and then introduced via one line. The hydrocarbon gas may be the same as the hydrocarbon gas introduced into the steam-methane reformer described above.

In addition, some of hydrocarbon gas input to the combined steam-carbon reformer 21 may also be input into a second burner 20 and burnt to be used as an energy source for heat supplied to the combined steam-carbon reformer 21.

The second conversion reactor 22 and the second adsorption separation process unit 23 are intended to perform the same functions as the first conversion reactor 12 and the first adsorption separation process unit 13 described above. Therefore, the contents described above for the first conversion reactor 12 and the first adsorption separation process unit 13 may be equally applied to the second conversion reactor 22 and the second adsorption separation process unit 23.

Furthermore, the first exhaust gas processor described above may be connected to the combined steam-carbon reformer 21, and the first exhaust gas processor may process exhaust gas discharged from the combined steam-carbon reformer 21. Furthermore, as described above, the first exhaust gas processor may process the exhaust gas discharged from the combined steam-carbon reformer and the steam-methane reformer together, thereby increasing economic efficiency of the overall process.

In addition, in the hydrogen production system of the present disclosure, the second adsorption separation process unit 23 may be connected to the second burner 20 to be in fluid communication therewith, and off-gas discharged from the second adsorption separation process unit 23 may be input into the second burner 20. Using the off-gas discharged from the second adsorption separation process unit 23 as fuel for the second burner 20, lost methane and steam may be minimized.

### Feed Controller

The hydrogen production system of the present disclosure may minimize carbon dioxide emissions by controlling flow rates of steam and hydrocarbon gas that are the feed input into the combined steam-carbon reformation process based on a composition and a flow rate of the off-gas discharged from the steam-methane reformation process and input into the combined steam-carbon reformation process in addition to connecting the steam-methane reformation process described above with the combined steam-carbon reformation process. To this end, the hydrogen production system of the present disclosure includes a feed controller 3 that controls the flow rates of steam and hydrocarbon gas introduced into the combined steam-carbon reformer 21 based on the composition and the flow rate of the off-gas flowing into the combined steam-carbon reformer 21 from the first adsorption separation process unit 13.

More specifically, the feed controller may include a flowmeter that may check the flow rate of the off-gas flowing into the combined steam-carbon reformer 21 from the first adsorption separation process unit 13, and a component analyzer that may check the components of the off-gas flowing into the combined steam-carbon reformer 21 from the first adsorption separation process unit 13.

When ratios of steam and hydrocarbon in the off-gas are high, the feed controller may lower the flow rates of steam and hydrocarbon gas input to the combined steam-carbon reformer. On the other hand, when the ratios of steam and hydrocarbon in the off-gas are low, the feed controller may increase the flow rates of steam and hydrocarbon gas input into the combined steam-carbon reformer, thereby inducing a uniform reaction within the combined steam-carbon reformer.

More specifically, the feed controller may control a molar flow rate of steam introduced into the combined steam-carbon reformer according to Equation 1 below.

$$[ Feed {H}_{2} O ] = [ {CO}_{2} ] \times [ Eq 2 ] - [ {H}_{2} O ] \qquad Equation 1$$

In the Equation, [CO₂] refers to a molar flow rate (kmol/hr) of carbon dioxide gas in the off-gas flowing into the combined steam-carbon reformer from the first adsorption separation process unit, [H₂O] refers to the molar flow rate (kmol/hr) of steam in the off-gas flowing into the combined steam-carbon reformer from the first adsorption separation process unit, and [Eq2] is a constant equal to or greater than 1.

In addition, the feed controller may control a molar flow rate of methane gas input into the combined steam-carbon reformer according to Equation 2 below:

$$[ Feed {CH}_{4} ] = ( [ {CO}_{2} ] \times ( 1 + [ Eq 2 ] ) ) / [ Eq 1 ] - [ {CH}_{4} ] \qquad Equation 2$$

In the Equation, [CO₂] refers to a molar flow rate (kmol/hr) of carbon dioxide gas in the off-gas flowing into the combined steam-carbon reformer from the first adsorption separation process unit,

[CH₄] refers to the molar flow rate (kmol/hr) of methane gas in the off-gas flowing into the combined steam-carbon reformer from the first adsorption separation process unit, [Eq1] is a constant between 1.5 and 2.0, and [Eq2] is a constant equal to or greater than 1.

The above [Eq1] and [Eq2] are constants that may be selected by an operator within appropriate ranges in implementing the hydrogen production system of the present disclosure. The amount of carbon dioxide emitted during the entire process may vary depending on the selection of the [Eq1] and [Eq2] values. From a viewpoint of minimizing the carbon dioxide emissions, the [Eq1] may preferably be the constant between 1.5 and 2.0, and the [Eq2] may be the constant equal to or greater than 1, preferably between 1 and 10.

In one example, the hydrogen production system of the present disclosure may further include a compressor 4 disposed between the first adsorption separation process unit 13 and the combined steam-carbon reformer 21, and the off-gas discharged from the first adsorption separation process unit 13 may pass through the compressor 4 and be input into the combined steam-carbon reformer 21. A pressure of the off-gas may be increased via the compressor.

### Method for Producing Hydrogen

The present disclosure provides a method for producing hydrogen using the hydrogen production system described above. More specifically, the present disclosure provides a method for producing hydrogen that includes allowing steam and methane to react with each other to obtain first stream containing carbon monoxide gas, steam, and hydrogen gas (Step 1), performing conversion reaction on the first stream to obtain second stream containing carbon dioxide gas and hydrogen gas (Step 2), obtaining hydrogen gas by separating the same from the second stream and adding and reacting additional steam and methane to the remaining off-gas to obtain third stream containing carbon monoxide gas, steam, and hydrogen gas (Step 3), performing the conversion reaction on the third stream to obtain fourth stream containing carbon dioxide gas and hydrogen gas (Step 4), and obtaining hydrogen gas by separating the same from the fourth stream (Step 5), wherein molar flow rates of additional steam and hydrocarbon gas introduced into the off-gas in Step 3 are determined via Equations 1 and 2 below:

$$[ Feed {H}_{2} O ] = [ {CO}_{2} ] \times [ Eq 2 ] - [ {H}_{2} O ] \qquad Equation 1$$

$$[ Feed {CH}_{4} ] = ( [ {CO}_{2} ] \times ( 1 + [ Eq 2 ] ) ) / [ Eq 1 ] - [ {CH}_{4} ] \qquad Equation 2$$

In the Equation, [CO₂] refers to a molar flow rate (kmol/hr) of carbon dioxide gas in the off-gas, [H₂O] refers to a molar flow rate (kmol/hr) of steam in the off-gas, [CH₄] refers to a molar flow rate (kmol/hr) of methane gas in the off-gas, [Eq1] is a constant between 1.5 and 2.0, and [Eq2] is a constant equal to or greater than 1.

The above method steps are performed in the steam-methane reformer 11, the first conversion reactor 12, the first adsorption separation process unit 13 and the combined steam-carbon reformer 21, the second conversion reactor 22, and the second adsorption separation process unit 23 in the hydrogen production system described above.

In addition, determining the molar flow rates of additional steam and hydrocarbon gas introduced into the off-gas in Step 3 via Equations 1 and 2 above is performed via the feed controller 3.

In the method for producing hydrogen of the present disclosure, a molar ratio between steam and methane gas introduced in Step 1 may be in a range from 2.5:1 to 4:1, preferably in a range from 3:1 to 4:1. This is to prevent the coking of the catalyst by introducing excessive steam.

In addition, in the method for producing hydrogen production of the present disclosure, the off-gas remaining after separating hydrogen gas in Step 5 may be used as an energy source in Step 3. Accordingly, lost components may be minimized and the economic efficiency of the overall process may be improved.

Hereinafter, the present disclosure will be described in more detail via Present Examples. However, Present Examples below are intended to illustrate the present disclosure and do not limit the scope of the present disclosure.

### EXPERIMENTAL EXAMPLE 1. DERIVATION OF OPTIMAL OPERATING RANGE WHEN USING FEED CONTROLLER

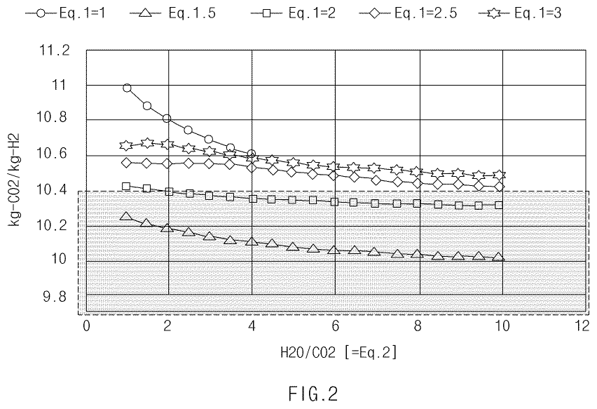

Via a simulation (program name: ASPEN HYSYS), the hydrogen production system as shown in FIG. 1 was constructed, and an amount of carbon dioxide generated in a reaction equilibrium state was calculated. More specifically, while change values of [Eq1] and [Eq2] in Equations 1 and 2 below, values of [Eq1] and [Eq2] that minimize the amount of carbon dioxide generated were identified, and results are shown in FIG. 2.

$$[ Feed {H}_{2} O ] = [ {CO}_{2} ] \times [ Eq 2 ] - [ {H}_{2} O ] \qquad Equation 1$$

$$[ Feed {CH}_{4} ] = ( [ {CO}_{2} ] \times ( 1 + [ Eq 2 ] ) ) / [ Eq 1 ] - [ {CH}_{4} ] \qquad Equation 2$$

In the above Equation, [CO₂] refers to a molar flow rate (kmol/hr) of carbon dioxide gas in the off-gas flowing into the combined steam-carbon reformer from the first adsorption separation process unit, [H₂O] refers to a molar flow rate (kmol/hr) of steam in the off-gas flowing into the combined steam-carbon reformer from the first adsorption separation process unit, and [CH₄] refers to a molar flow rate (kmol/hr) of methane gas in the off-gas flowing into the combined steam-carbon reformer from the first adsorption separation process unit.

As may be seen in FIG. 2, it was found that the amount of carbon dioxide generated decreases when [Eq1] is in the range from 1.5 to 2.0 and [Eq2] is equal to or greater than 1. Accordingly, it was found that a great amount of hydrogen may be produced while minimizing carbon dioxide generation by constructing the hydrogen production system as in the present disclosure and controlling the molar flow rates of water and methane gas input into the combined steam-carbon reformer via the feed controller.

In the hydrogen production system of the present disclosure, the off-gas containing carbon dioxide generated as the result of the steam-methane reformation process is used as the feed in the combined steam-carbon reformation process, and the flow rates of steam and hydrocarbon gas separately introduced in the combined steam-carbon reformation process are controlled based on the composition and the flow rate of the off-gas, so that the amount of carbon dioxide ultimately emitted may be greatly reduced while producing high purity hydrogen gas.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. A hydrogen production system comprising:
a steam-methane reformer configured to receive steam and hydrocarbon gas;
a first conversion reactor in fluid communication with the steam-methane reformer;
a first adsorption separation process unit in fluid communication with the first conversion reactor and configured to separate high purity hydrogen gas;
a combined steam-carbon reformer configured to receive steam and hydrocarbon gas;
a second conversion reactor in fluid communication with the combined steam-carbon reformer; and
a second adsorption separation process unit in fluid communication with the second conversion reactor and configured to separate high purity hydrogen gas;
wherein the first adsorption separation process unit is connected to and in fluid communication with the combined steam-carbon reformer; and
wherein the hydrogen production system includes a feed controller configured to control flow rates of steam and hydrocarbon gas introduced into the combined steam-carbon reformer based on a composition and a flow rate of off-gas flowing into the combined steam-carbon reformer from the first adsorption separation process unit.

2. The hydrogen production system of claim 1, further comprising:
a first burner configured to receive hydrocarbon gas and to supply energy to the steam-methane reformer.

3. The hydrogen production system of claim 2, further comprising:
a second burner configured to receive hydrocarbon gas and to supply energy to the combined steam-carbon reformer.

4. The hydrogen production system of claim 1, further comprising:
a compressor disposed between the first adsorption separation process unit and the combined steam-carbon reformer,
wherein off-gas discharged from the first adsorption separation process unit passes through the compressor and is input into the combined steam-carbon reformer.

5. The hydrogen production system of claim 1, further comprising:
a first exhaust gas processor connected to the steam-methane reformer and configured to process exhaust gas discharged from the steam-methane reformer.

6. The hydrogen production system of claim 5, wherein the first exhaust gas processor is connected to the combined steam-carbon reformer,
wherein the first exhaust gas processor processes exhaust gas discharged from the combined steam-carbon reformer.

7. The hydrogen production system of claim 3, wherein the second adsorption separation process unit is connected to and in fluid communication with the second burner,
wherein off-gas discharged from the second adsorption separation process unit is input into the second burner.

8. The hydrogen production system of claim 1, wherein the feed controller is configured to control a molar flow rate of steam introduced into the combined steam-carbon reformer according to Equation 1:
$$[ Feed {H}_{2} O ] = [ {CO}_{2} ] \times [ Eq 2 ] - [ {H}_{2} O ] ;$$
wherein [CO₂] refers to a molar flow rate (kmol/hr) of carbon dioxide gas in off-gas flowing into the combined steam-carbon reformer from the first adsorption separation process unit,
[H₂O] refers to the molar flow rate (kmol/hr) of steam in off-gas flowing into the combined steam-carbon reformer from the first adsorption separation process unit, and
[Eq2] is a constant equal to or greater than 1.

9. The hydrogen production system of claim 1, wherein the feed controller is configured to control a molar flow rate of methane gas introduced into the combined steam-carbon reformer according to Equation 2:
$$[ Feed {CH}_{4} ] = ( [ {CO}_{2} ] \times ( 1 + [ Eq 2 ] ) ) / [ Eq 1 ] - [ {CH}_{4} ] ;$$
wherein [CO₂] refers to a molar flow rate (kmol/hr) of carbon dioxide gas in off-gas flowing into the combined steam-carbon reformer from the first adsorption separation process unit,
[CH₄] refers to the molar flow rate (kmol/hr) of methane gas in off-gas flowing into the combined steam-carbon reformer from the first adsorption separation process unit,
[Eq1] is a constant between 1.5 and 2.0, and
[Eq2] is a constant equal to or greater than 1.

10. The hydrogen production system of claim 1, wherein the feed controller includes:
a flowmeter configured to check the flow rate of off-gas flowing into the combined steam-carbon reformer from the first adsorption separation process unit; and
a component analyzer configured to check components of off-gas flowing into the combined steam-carbon reformer from the first adsorption separation process unit.

11. A method for producing hydrogen, the method comprising:
allowing steam and methane gas to react with each other to obtain first stream containing carbon monoxide gas, steam, and hydrogen gas;
performing conversion reaction on the first stream to obtain second stream containing carbon dioxide gas and hydrogen gas;
obtaining hydrogen gas by separating the hydrogen gas from the second stream and adding and reacting additional steam and methane gas to remaining off-gas to obtain third stream containing carbon monoxide gas, steam, and hydrogen gas;
performing the conversion reaction on the third stream to obtain fourth stream containing carbon dioxide gas and hydrogen gas; and
obtaining hydrogen gas by separating the hydrogen gas from the fourth stream;
wherein molar flow rates of additional steam and hydrocarbon gas introduced into off-gas in the separating of the hydrogen gas from the second stream are determined via Equation 1:
$$[ Feed {H}_{2} O ] = [ {CO}_{2} ] \times [ Eq 2 ] - [ {H}_{2} O ] ;$$
and
Equation 2:
$$[ Feed {CH}_{4} ] = ( [ {CO}_{2} ] \times ( 1 + [ Eq 2 ] ) ) / [ Eq 1 ] - [ {CH}_{4} ] ;$$
wherein [CO₂] refers to a molar flow rate (kmol/hr) of carbon dioxide gas in off-gas,
[H₂O] refers to a molar flow rate (kmol/hr) of steam in off-gas,
[CH₄] refers to a molar flow rate (kmol/hr) of methane gas in off-gas,
[Eq1] is a constant between 1.5 and 2.0, and
[Eq2] is a constant equal to or greater than 1.

12. The method of claim 11, wherein a molar ratio between steam and methane gas \is in a range from 2.5:1 to 4:1.

13. The method of claim 11, wherein off-gas remaining after separating hydrogen gas is used as an energy source in the separating of the hydrogen gas from the second stream.
